(19) United States
(12) Patent Application Publication
(10) Pub. No.: US 2015/0067494 A1
(43) Pub. Date: Mar. 5, 2015

(54) PRINT TO DISPLAY ON MOBILE DEVICE

(71) Applicant: Tomoki Hattori, Suwanee, GA (US)

(72) Inventor: Tomoki Hattori, Suwanee, GA (US)

(73) Assignee: RICOH COMPANY, LTD., Tokyo (JP)

(21) Appl. No.: 14/018,689

(22) Filed: Sep. 5, 2013

(51) Int. Cl. G06F 17/21

(52) U.S. Cl. CPC G06F 17/212
USPC 715/274

(57) ABSTRACT

Text data received or retrieved by a mobile apparatus is printed to a print-ready file that is configured to capture the text data with a page format and width and a display font that is visually acceptable on a display of a mobile apparatus, so that the print-ready file is displayed on the display of the mobile apparatus without horizontal cutoff of the text data.

### TECHNICAL FIELD

This disclosure relates to tools (systems, apparatuses, methodologies, computer program products, etc.) for customizing display of text on a mobile apparatus.

### BACKGROUND

In the current digital age, the trend is that more and more tasks involve use of information technology (IT) and digital media. Due to the proliferation of IT and other technologies, as well as changes in our society to ever higher levels of mobility, expectations of access to information while on-the-go is becoming part of the current day culture. Consequently, virtually every individual in our society carries one or more mobile devices (such as tablet or notebook computers, smartphones and other handsets with a display, etc.) to facilitate such access.

The ever more sophisticated mobile devices allow users to access information via any of various media. For example, e-mail and messaging are popular means to communicate information, such as when an oral conversation is not possible, convenient, suitable, etc., as well as in other circumstances. Further, the web provides a whole world of available content and information. In addition, software applications running on the mobile devices may allow the user to access content or information through the Internet and/or another data network.

However, when such information is viewed on a mobile device (such as a handset) that has a small display area, it can be very difficult to view the information or content, such as, for example, in the case that information or content is text that spans across the entire line width and then wraps around to the next line (and so on). If the device is set up to display at a viewable text size or font, the line would largely be cut off, and although the user can typically scroll horizontally, it is a tedious task when the content includes text wrapped across several lines (requiring many scroll operations to view the text in its entirety). On the other hand, such devices can be set to display the entire content in one screen (by shrinking or zooming out, when necessary), but such arrangement leads to a presentation that is essentially unviewable (at least by one of ordinary human vision).

There is a need to for an improved approach for displaying information or content on a device having a relatively small-sized display.

### SUMMARY

Various tools (for example, a system, an apparatus, application software, etc.) can be configured to enable a useful and customized display of text and other content to be provided on a mobile device, particularly one with a relatively smaller display area. Thus, text and other information can be displayed on a display of a handset without (or with minimal) horizontal cutoff of text.

In an aspect of this disclosure, a mobile apparatus is configured to include a layout conversion part or unit (such as software instructions executed by a processing unit of the device) that formats data received through a network or retrieved from local storage, to conform displayed text to screen size or width of said mobile apparatus (that is, so that there is little, if any, horizontal cutoff).

For example, text data is retrieved from a data source or a file, and the layout conversion part or unit determines, based on device display information associated with the mobile apparatus, (i) a particular display font that is visually acceptable on a display of the mobile apparatus to a user and (ii) a particular page format and/or a particular page width to permit the text data to be displayed on the display of the mobile apparatus at the particular display font, and causes the text data to be printed to a print-ready file that is configured to capture the text data with the particular display font and the particular page format and/or width, and to be displayed on the display without horizontal cutoff of the text data.

In another aspect, such re-formatted data is saved as a print-ready file on the mobile apparatus, to capture the original data (albeit in a different presentation customized for the particular display of the device). Such print-ready file can effectively capture the original data or information to allow the content to be displayed at a later time on the display of the device, regardless of particular versions of the operating platform or absence or presence of the software application that would normally generate such a print ready file.

In another aspect, the user can be prompted to select whether to operate in image priority mode or in text priority mode. In the case that the text priority mode is selected, text data is routinely converted to a print-ready file, based on display font, page format, page width, etc. On the other hand, if image priority mode is selected, text data is not converted to a different format, and instead text is displayed based on a native page format or a default format.

In another aspect, the layout conversion part employs user preference information to determine the appropriate conversion to be applied to the text data. For example, the user preference information may include information registering font options selected by the user. Such user-selected font can be presumed to correspond to a text size which is acceptable to the user, and can be a factor for determining an appropriate display for the user.

### BRIEF DESCRIPTION OF THE DRAWINGS

The aforementioned and other aspects, features and advantages can be more readily understood from the following detailed description with reference to the accompanying drawings wherein:

FIG. 1A shows a block diagram of a mobile apparatus, in accordance with an exemplary embodiment;

FIG. 1B shows a block diagram illustrating a system, in accordance with another exemplary embodiment;

FIG. 1C shows a block diagram illustrating a system, in accordance with another exemplary embodiment;

FIG. 2 shows a block diagram illustrating a system, in accordance with another exemplary embodiment;

FIG. 3 shows a block diagram illustrating a system, in accordance with another exemplary embodiment;

FIG. 4A shows a block diagram of an exemplary configuration of a computing device;

FIG. 4B shows a block diagram of an exemplary configuration of a multi-function device;

FIG. 4C shows a block diagram of an exemplary configuration of a terminal;

FIG. 5 shows an example of device display information;

FIG. 6 shows a flow chart illustrating a method performed by a mobile apparatus, such as mobile apparatus 100A shown in FIG. 1A or mobile terminal 106 shown in FIGS. 1B-1C, in accordance with an exemplary embodiment;

FIG. 7 shows a flow chart illustrating a method performed by a mobile apparatus, in accordance with another exemplary embodiment;

FIG. 8A shows an example of a user interface display screen configured to be displayed by a mobile apparatus, in accordance with an exemplary embodiment;

FIG. 8B shows an example of a user interface display screen configured to be displayed by a mobile apparatus, in accordance with another exemplary embodiment;

FIG. 9A shows an example of a user interface display screen configured to be displayed by a mobile apparatus, in accordance with another exemplary embodiment;

FIG. 9B shows an example of a user interface display screen configured to be displayed by a mobile apparatus, in accordance with another exemplary embodiment;

FIG. 10 shows a flow chart illustrating a method performed by a mobile apparatus, in accordance with another exemplary embodiment;

FIG. 11A shows an example of a printed image;

FIG. 118 shows an example of a user interface display screen configured to be displayed by a mobile apparatus, in accordance with another exemplary embodiment;

FIG. 12 shows a flow chart illustrating a method performed by a mobile apparatus, in accordance with another exemplary embodiment;

FIG. 13A shows an example of a user interface display screen;

FIG. 13B shows an example of a user interface display screen configured to be displayed by a mobile apparatus, in accordance with another exemplary embodiment;

FIG. 14 shows another example of a user interface display screen;

FIG. 15 shows another example of a user interface display screen;

FIGS. 16A-16B show examples of user interface display screens, displayed in text priority mode; and

FIG. 17 shows a user preference table.

### DETAILED DESCRIPTION

This patent specification describes tools (in the form of methods, apparatuses and systems) that reformats content for display on a limited size (and/or width) display and capturing such reformatted data in a file (which can be archived for later display without the application that created the original data), even when the original data is formatted for a wide line presentation in an application or otherwise. The tools convert the data, document, content, etc., which may have been created with a specific application, to a print-ready format (that is, ready to be printed) which is independent of computing platform can be displayed without using the specific application that created the original data.

In describing exemplary embodiments illustrated in the drawings, specific terminology is employed for the sake of clarity. However, the subject matter of this patent specification is not intended to be limited to the specific terminology so selected and it is to be understood that each specific element includes all technical equivalents that operate in a similar manner.

The drawings show examples of implementations of the subject matter of this patent disclosure in several computing environments. However, it should be understood that the subject matter of this disclosure can be utilized by any computing device including but not limited to PDAs, cell phones, personal, notebook and workstation computers, kiosks, other information terminals, etc. In addition, the subject matter of this disclosure might be provided as services in a modular fashion by other devices connected by a communication network.

Referring now to the drawings, wherein like reference numerals designate identical or corresponding parts throughout the several views, there is described tools (systems, apparatuses, methodologies, computer program products, etc.) for printing information and documents stored on a mobile terminal apparatus.

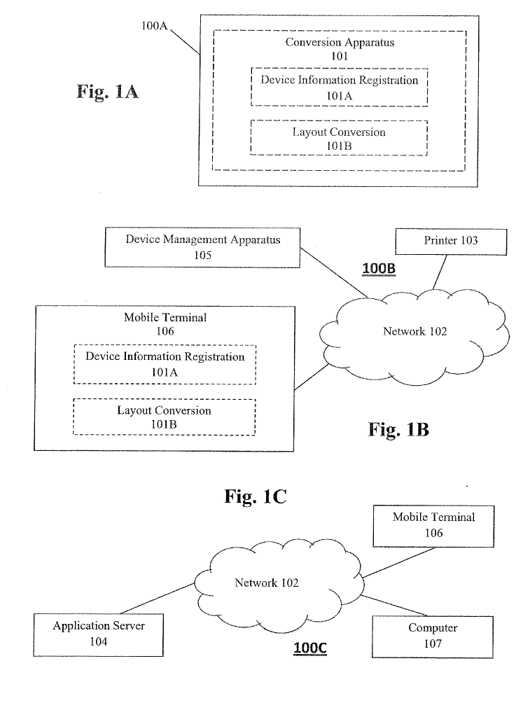

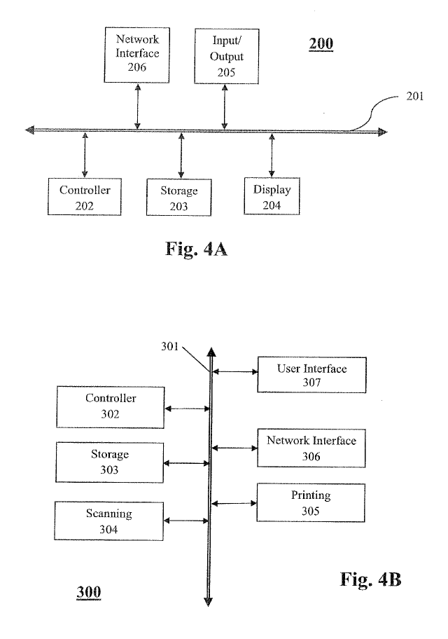

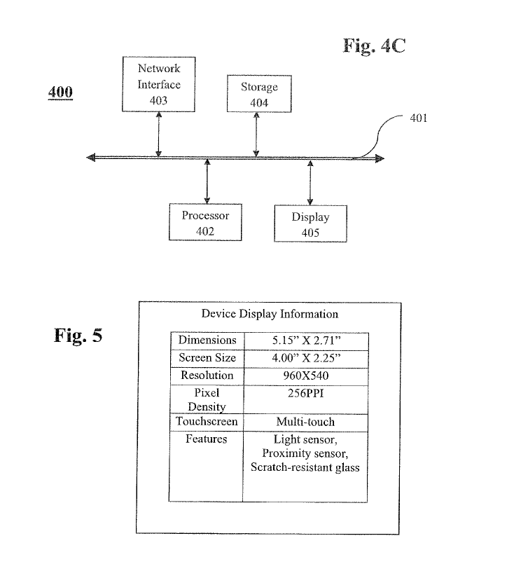

FIG. 1A shows a mobile apparatus 100A configured with a conversion apparatus 101 to include a device information registration part 101A and a layout conversion part 101B. The mobile apparatus 100A can be implemented on any device including a processor, storage and display, such as, but not limited to, a smartphone, a handset, a tablet, other information terminals, etc., for example, having a configuration such as shown in FIG. 4A.

The device information registration part 101A is configured to register, maintain and/or retrieve stored device information. Such device information may be the typical information maintained on a mobile terminal device, such as device configuration information (e.g., indicating hardware and software configurations, such as firmware version number, power capabilities), and/or other information (such as hardware ID) that a user or administrator may need or wish to know regarding the device. The device information includes device display information, such as, for example, display dimensions, screen size, resolution, pixel density, display type, other display features, etc., of a mobile terminal, such as shown in FIG. 5. The information depicted in FIG. 5 is merely exemplary, and a wide range of other information may be included in the device information. Although the device information may be stored natively on the host device, some or selected information may be retrieved from another device, such as a device management server or system, periodically or as needed.

The layout conversion part 101B is configured to format (or reformat) data retrieved from storage or received from another source, for display on the native display. Importantly, as discussed in more detail below, the textual content is displayed without horizontal cutoff, by considering page format, page width, display font, etc., such as might be determined from device display information, user preferences or settings (or other historical use information), or direct user input. Further, in order to ensure that such formatted or reformatted textual content is captured for later access, it is printed to a print-ready file. Printing to file is an approach that saves spacing and other layout information so a printer can reproduce the on-screen version of a file without access to the program or computer used to create it. Such approach (i.e. print to file) is typically employed to send a document or photo to a destination electronically, as a substitute for mailing a hardcopy, or in some other circumstances, such as when a professional printing service is needed to obtain a hardcopy output that does not compromise visual information.

The mobile apparatus 100A may be an application, or some other software component (such as part of the operating system or a device driver), on a mobile terminal device. Such mobile terminal preferably is configured to communicate through a data network to obtain content and data from an external source. However, it should be appreciated that the inventive aspects described herein can be employed even if the mobile device is not configured to connect to such data network, and/or is not connected to the data network.

FIG. 1B shows schematically an example in which a system 100B includes a mobile terminal 106, a printer 103 and a device management apparatus 105, each of which is connected to the network 102. FIG. 1C shows schematically another example, in which each of application server 104, mobile terminal 106 and computer 107 is connected to the network 102, in system 100C. While only the printer 103 and the device management apparatus in FIG. 1B and only the application server 104 and computer 107 in FIG. 1C, other than the mobile terminal 106, are connected to the network 102, it should be appreciated that the network environment can have an arbitrary number of devices (of various type).

The network 102 can be any data network, a local area network, a wide area network or any type of network such as an intranet, an extranet (for example, to provide controlled access to external users, for example through the Internet), a private or public cloud network, the Internet, etc., or a combination thereof. Further, other communications links (such as a virtual private network, a wireless link, etc.) may be used as well for the network 102. In addition, the network 102 preferably uses TCP/IP (Transmission Control Protocol/Internet Protocol), but other protocols such as SNMP (Simple Network Management Protocol) and HTTP (Hypertext Transfer Protocol) can also be used. How devices can connect to and communicate over networks is well-known in the art and is discussed for example, in “How Networks Work”, by Frank J. Derfler, Jr. and Les Freed (Que Corporation 2000) and “How Computers Work”, by Ron White, (Que Corporation 1999), the entire contents of each of which are incorporated herein by reference.

The printer 103 can be a device having printing functionality, with or without providing additional functionalities such as copying, scanning, fax, etc. The printer 103 may be configured as shown in FIG. 4B, which is discussed infra.

The device management apparatus 105 can be any of the various device management tools (such as application software, etc.) that are available to IT administrators to assist the administrators to track, monitor and otherwise manage IT (information technology) devices connected to a network. Such device management tools retrieve device settings or other device information from the devices, or other device data sources, through a network, and register such device information and allow the IT administrators to manage the devices. Thus, in the example of FIG. 1B, the mobile terminal 106 can obtain device information from the device management apparatus 105 through the network 102, and selectively register device information specific to the mobile terminal 106 or display unit of the mobile terminal 106.

Application server 104 can be configured to communicate with mobile terminal 106, through the network 102, to provide an application (such as a document storage and conversion application) to the mobile terminal 106 (or another device connected to the network 102), on demand. Such application may include the layout conversion part 101B alone, or the layout conversion part 101B and the device information registration part 101A.

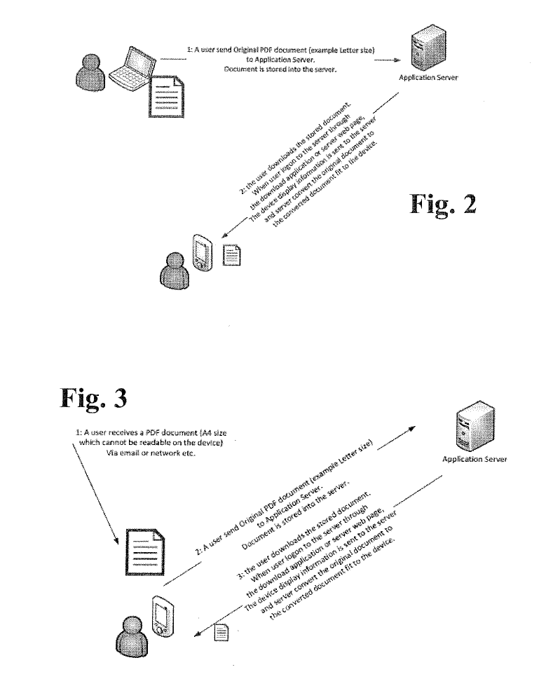

For example (FIG. 2), a user employing the computer 107 sends an original PDF (portable document format) document formatted to have letter-size pages to the application server 104 for storage. At a later time, the same user or another user with access rights to the stored document operates the mobile terminal 106 to retrieve the stored document. More specifically, when the user logs on to the server 104, such as via application software on the mobile terminal 106, or through a web portal via browser application on the mobile terminal 106, the application server 104 obtains device display information from the mobile terminal 106 and then converts the document to appropriate format so that the document can be displayed on the display of the mobile terminal 106 without horizontal cutoff. The converted document is returned to the mobile terminal 106 in such format that has been customized for the display of the mobile terminal 106.

In the example shown in FIG. 3, a user of the mobile terminal 106 receives (e.g., via e-mail, via network access, etc.) a PDF document that has been formatted for A4 size. Such A4-sized document cannot be properly displayed for easy review on the display of the mobile terminal 106 via a typical PDF viewer. Accordingly, the user sends the received original document to the application server 104 which in turn stores the document. At a later time, as in the example of FIG. 2, the user logs on to the server 104 to retrieve the stored document, and the application server 104 obtains device display information from the mobile terminal 106 and then converts the document to appropriate format so that the document can be displayed on the display of the mobile terminal 106 without horizontal cutoff.

In each of the examples of FIGS. 2 and 3, the mobile terminal 106 operates largely as a thin client, at least with respect to the layout conversion part. However, it should be appreciated that the layout conversion can alternatively be performed locally on the host device.

The application server 104 can be configured as shown by way of example in FIG. 4C. Operations and configurations of application servers are well-known in the art and therefore, in the interest of brevity (and so as not to obscure the inventive aspects described herein), are not discussed at length herein.

An example of a configuration of a user terminal (e.g., the mobile terminal 106) or computer (e.g., computer 107) is shown schematically in FIG. 4A. In the example of FIG. 4A, terminal device 200 includes a controller (or processor) 202 that communicates with a number of other components, including storage 203, display 204, input/output (such as mouse, touchpad, stylus, microphone and/or speaker with voice/speech interface and/or recognition software, etc.) 205 and a network interface 206, by way of an internal bus 201.

The storage 203 can provide storage for program and data, and may include a combination of assorted conventional storage devices such as buffers, registers and memories [for example, read-only memory (ROM), programmable ROM (PROM), erasable PROM (EPROM), electrically erasable PROM (EEPROM), static random access memory (SRAM), dynamic random access memory (DRAM), non-volatile random access memory (NOVRAM), etc.].

The network interface 206 provides a connection (for example, by way of an Ethernet connection or other network connection which supports any desired network protocol such as, but not limited to TCP/IP, IPX, IPX/SPX, or NetBEUI) to a network (e.g., network 102) to enable the terminal device to communicate with another device through the network.

FIG. 4B shows a schematic diagram of a configuration of a printing device as a printer, according to an exemplary embodiment, which can be any apparatus that has the ability to print images on a medium.

The printer 300 shown in FIG. 4B includes a controller 302, and various elements connected to the controller 302 by an internal bus 301. The controller 302 controls and monitors operations of the printer 300. The elements connected to the controller 302 include storage 303 (for example, random access memory, read-only memory, semiconductor memory cards, etc.), printing engine 305, and a network interface (I/F) 306.

Program code instructions can be stored in one or more parts or devices of storage 303 and executed by the controller 302 to carry out the instructions. Such instructions can include instructions for performing specified functions (such as printing, scanning, faxing, copying, e-mailing, etc.) of the printer 300, to enable the printer 300 to interact with a terminal, as well as perhaps other external devices, through the network interface 306, and interactions with users through the user interface 307.

The network interface 306 is utilized by the printer 300 to communicate with other network-connected devices such as a terminal (e.g. a mobile terminal apparatus of FIG. 1A) and receive data requests, print jobs, user interfaces, etc. Printing 305, scanning 304 and network interface 306 are otherwise conventional, and therefore, a detailed description of such conventional aspects is omitted in the interest of clarity and brevity.

The printer 300 can have any or all of the functions of similar devices conventionally known, such as for scanning, editing and storing images, sending a fax, sending and receiving e-mails with or without attachments, accessing files by FTP or another protocol or facility, surfing the Web, etc. Further, multi-functional devices or multi-function peripheral devices can play a prominent role to convert hardcopy documents to electronic documents.

FIG. 4C shows an exemplary constitution of a computer 400 which can be configured by appropriate programming to operate as the device management apparatus 105 (FIG. 1B) or as the application server 104 (FIG. 1C). The computer 400 shown in FIG. 4C includes a processor 402, and various elements connected to the processor 402 by an internal bus 401, such as a network interface 403, storage 404 and display 405. The processor 402 processes incoming requests transmitted through the network interface 403. The network interface 403 enables the application server 400 to communicate with other network-connected devices such as a terminal (e.g., the mobile terminal 106 of FIG. 1B or FIG. 1C) and receive data or service requests.

FIG. 5 illustrates an example of a tabular representation of device display information 501, including various information reflecting or corresponding to the display of the mobile terminal 106. The device display information table 501 may include, but is not limited to, the information shown in FIG. 5. The dimensions information indicates the physical length and width of the specific mobile terminal apparatus. The screen size information indicates the physical length and width of the display area of the mobile terminal apparatus. The resolution information indicates the maximum pixels allowed to be displayed on the display area in the horizontal and vertical direction. The pixel density information indicates the density of pixels in units of pixels per inch. The touchscreen information indicates the capabilities of the display unit which, in the example of FIG. 5, is a touchscreen display. In such example, multi-touch information indicates ability of the touch sensing surface to recognize the presence of two or more points of contact with the surface. This plural-point awareness is often used to implement advanced functionality such as pinch to zoom or activating predefined programs. The features information indicates additional features of the mobile terminal.

The layout conversion part 101B can employ such display information and/or other information to determine an appropriate conversion of incoming data (i.e. retrieved from native storage or obtained from another source) so that. The layout conversion part 101B has limitations in terms of the width of the display and resolution based on the specifications of the mobile terminal 106, shown in the table.

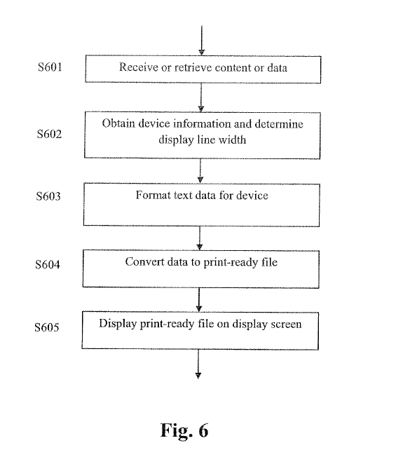

A process by which the layout conversion part 101B formats text data for display on a display of the mobile terminal 106 is discussed below with reference to FIG. 6.

When data or content is retrieved by the mobile terminal 106 from storage (local or external) or is received from an external source (step S601), the layout conversion part 101B retrieves device information of the mobile terminal 106, such as registered by the device information registration part 101A of the mobile terminal 106, or from another device information source, such as the device management apparatus 105 (step 602).

Further, the layout conversion part 101B determines a display line width, as well as a display font that is acceptable to the user. The display line width may be a parameter (e.g., device display information) included in the device information or may be determined from various other device information. For example, the display line width may be determined based on device dimensions and/or screen size information, with or without accounting for a horizontal margin.

In addition, the layout conversion part 101B determines a display font that is acceptable to the user. For example, the display font may be registered as a default value (e.g., generally acceptable to most users) or as a user preference, i.e. user-specified, or determined based on historical user settings. The display font may additionally or alternatively be based on display size and resolution.

As discussed in more detail infra, the user may be permitted to manipulate size of displayed text, in order to arrive at a font that is optimal or at least satisfactory to the user. Such selection can be registered as the user preferred font and/or history of user settings, to be utilized by the layout conversion part in determining then, or at a later time, a suitable display for the user.

The user may perform such manual settings of the display with only the knowledge that the current displayed text is affected (that is, it may be transparent to the user that his/her setting is being tracked and registered to affect future use), or the user may be informed that the setting is to be applied going forward until the setting is changed again.

In any event, with the particular font and particular display line width determined, the layout conversion part 101B then formats the retrieved data to such font and display line width (step S603). That is, the maximum number of characters of the particular font that can fit across the particular display line width, with or without a tolerance, is determined.

The formatted data is then converted to a print-ready file by the layout conversion part 101B (step S604) and the print-ready file is displayed on the display screen (step S605). The print-ready file is preferably stored along with the original data.

It should be appreciated that the retrieved or received data or content may include text data as well as other data so as to constitute, for example, multimedia data. In a case where the user is only interested in viewing text data (e.g., in order to avoid draining the battery, such as from playing animation, video, audio, etc.), other forms of content may be omitted from output on the mobile terminal. Optionally, graphic info (such as an icon) may appear within the text data, to permit the user to access the other content by activating the icon (i.e. embedded link associating such icon with said other content). Such additional content may be provided while the text data remains on display, or alternatively, may be opened in a different application.

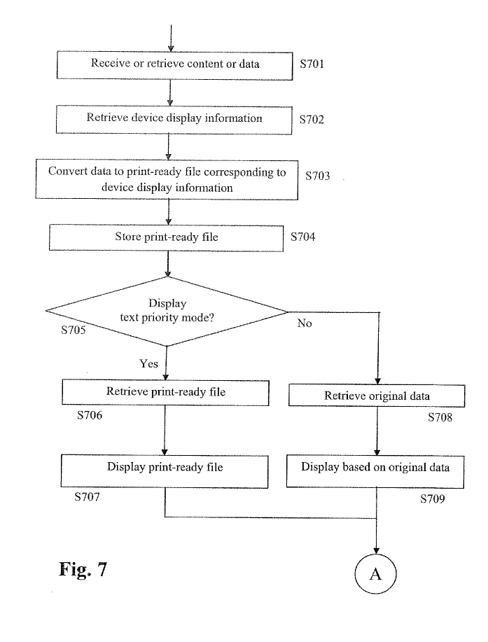

FIG. 7 shows a process by which the layout conversion part 101B determines whether reformat the display of text, in accordance with user preference, according to an exemplary embodiment of this disclosure.

As in a previous embodiment, when data or content is retrieved by the mobile terminal 106 from storage (local or external) or is received from an external source (step S701), the layout conversion part 101B retrieves device information of the mobile terminal 106, such as registered by the device information registration part 101A of the mobile terminal 106 (step S702). With this information the layout conversion part 101B converts the data to a print-ready file with a particular display font, format and page width corresponding the device display information so that the data can be displayed without horizontal cutoff (step S703). The default font chosen by the layout conversion part 101B to format the original data may be set to a predetermined value, based on the display area of the mobile terminal apparatus, so that the user can easily read the data by scrolling vertically through the data. The original data and print-ready file are then stored in the Storage of the mobile terminal (step S704).

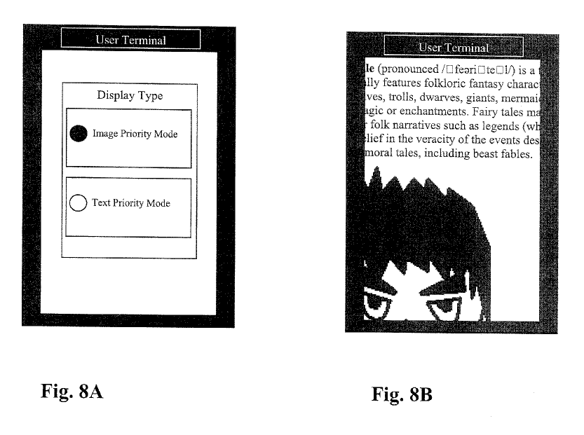

The layout conversion part 101B can be configured to prompt (see, e.g., FIG. 8A) the user to choose a display mode (step S705). Should the user choose to display the data in text priority mode (S705, Yes), the layout conversion part 101B retrieves the print-ready file from the storage of the mobile terminal (step 706) and displays the print-ready file on the display of the mobile terminal 106 (step 707).

On the other hand, in the case in which the user chooses to display the data in image priority mode (S705, No), the layout conversion part 101B retrieves the original data from the storage of the mobile terminal (step S708) and displays the original data on the display of the mobile terminal 106 (step 709).

FIG. 8B illustrates an example of the mobile terminal 106 operating in image priority mode in which the display content is based on the original data. That is, the content is displayed on the display screen in its original font and page format, and the text is not reformatted to avoid no horizontal cutoff. Instead, in such example shown in FIG. 8B, the user needs to scroll horizontally in order to view the remaining text on each of the displayed lines of text.

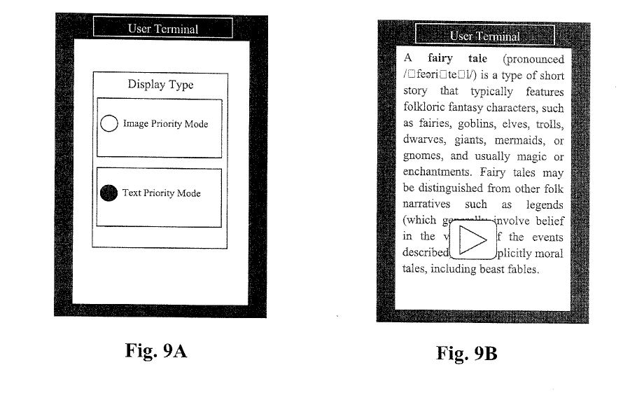

On the other hand, in the example of FIGS. 9A-9B, the user selects text priority mode, through the user interface. As shown in FIG. 9B, the textual content has been converted by the layout conversion part 101B, so that there is no horizontal cutoff. The user is only required to scroll vertically in order to view all of the text. In the example shown in FIG. 9B, an icon is embedded within the text, and the user can access other content by selecting the icon to activate the link to such other content.

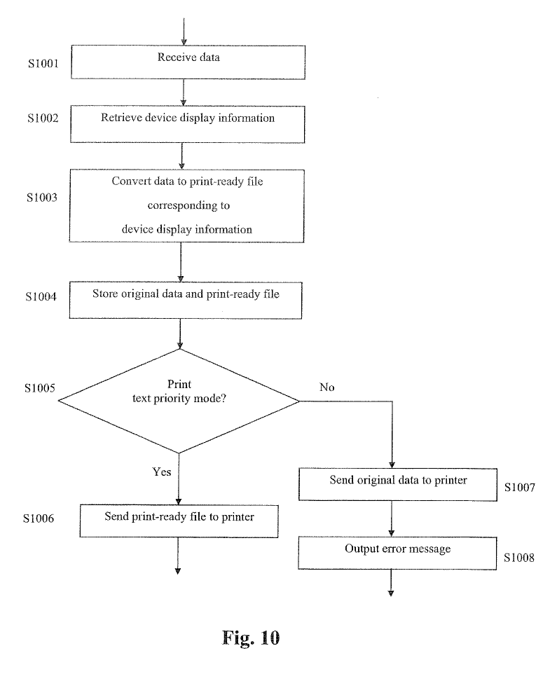

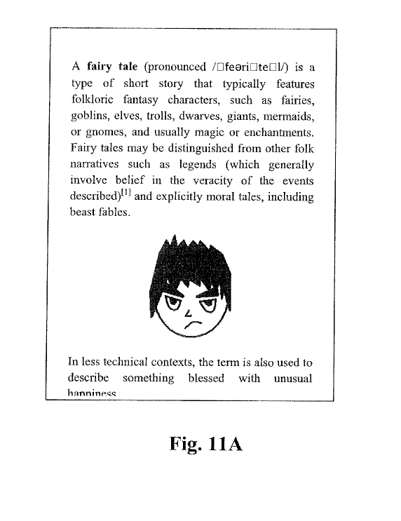

The user may also choose to print the data or content in either text priority mode or in image priority mode, such as in the process shown in FIG. 10.

As in a previous embodiment, when data or content is retrieved by the mobile terminal 106 from storage (local or external) or is received from an external source (step S1001), the layout conversion part 101B retrieves device information of the mobile terminal 106, such as registered by the device information registration part 101A of the mobile terminal 106 (step S1002). With this information the layout conversion part 101E converts the data to a print-ready file with a particular display font, format and page width corresponding to the device display information (step S1003). The original data and print-ready file are then stored in the storage of the mobile terminal (step S1004).

When the mobile terminal 106 receives an instruction to print the data or content (step S1005), the layout conversion part 101B can prompt the user to choose as between text priority mode and image priority mode (step S1006). Should the user choose text priority mode, the layout conversion part 101B retrieves the print-ready file from the storage of the mobile terminal (step 1007) and sends it to the printer 103.

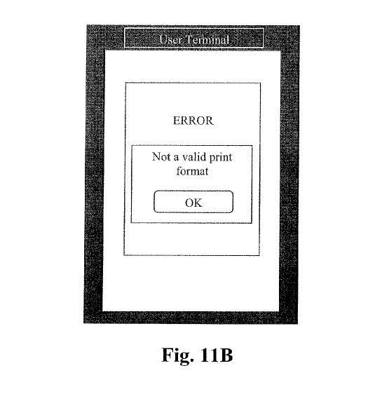

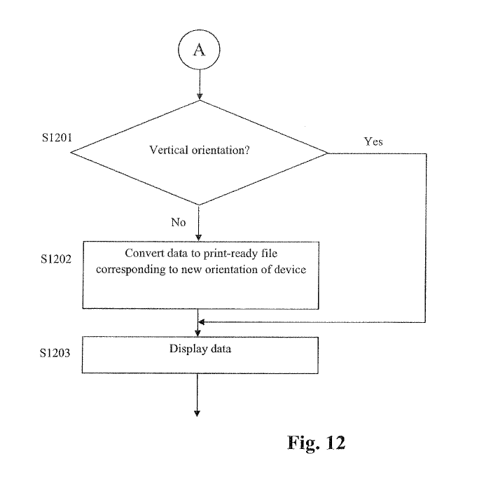

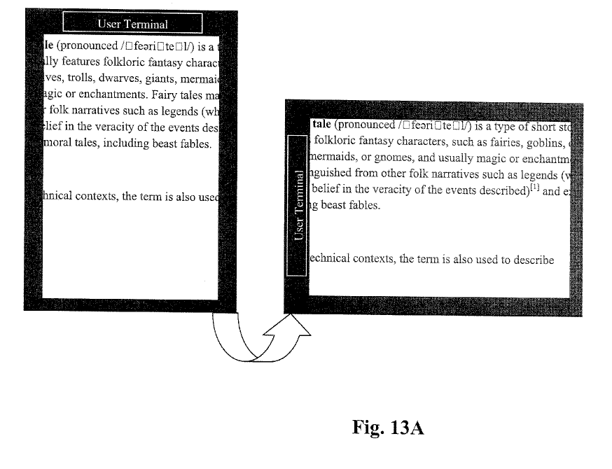

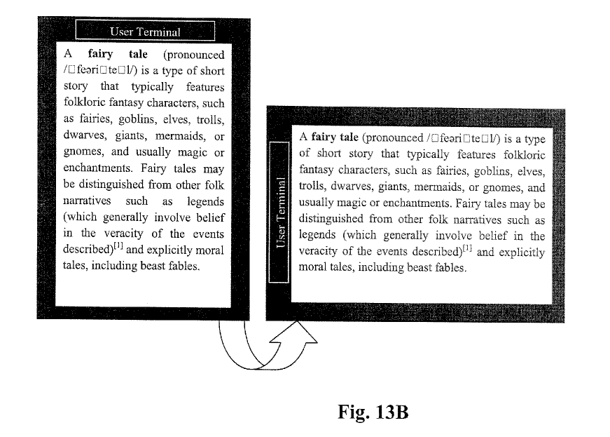

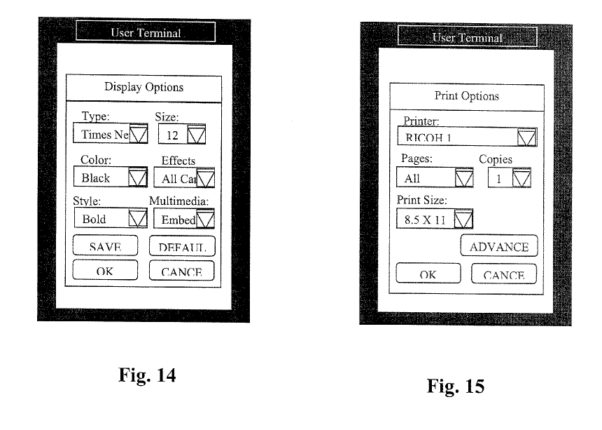

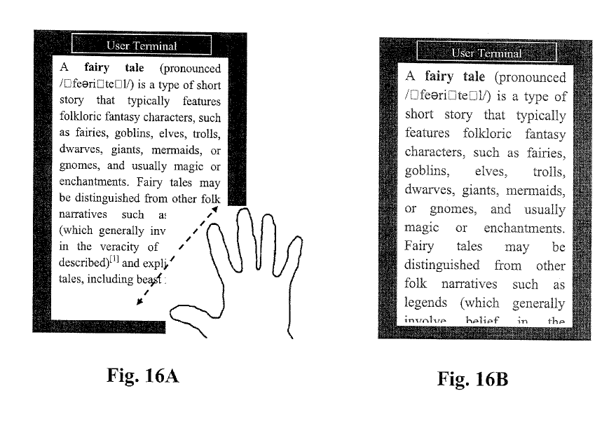

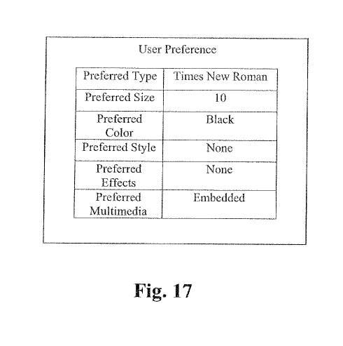

In the case in which the user chooses to image priority mode, the layout conversion part 101B retrieves the original data from the storage of the mobile terminal and sends the original data to the printer (step S1008). However, if the original data is not in a format recognizable by a printer, then it would not be possible to print the original data without an additional application. In such instance, the layer conversion part 101B can be configured to output an error message (see, e.g., FIG. 11B) to the display (step S1009).

FIG. 11A shows an example of a hardcopy page of the print-ready file formatted by the layer conversion part 101B. In such example, the print-ready file has been formatted to print with specific margins to correspond with the printing medium. On the other hand, the layout conversion part 101B can prompt the user to specify margins and settings, before proceeding with conversion and printing. For example, although the print-ready file in the example shown in FIG. 11A contains graphics. The user can specify to the layout conversion part 101B not to include graphics within the text area, and in such circumstance, the print-ready file sent to the printer would not contain the graphics and the hardcopy would only contain formatted text data.

FIG. 12 shows a process that may be optionally applied, to adjust the print-ready file additionally based on orientation of the display, according to another exemplary embodiment. For example, after the layout conversion part 101B has applied the process shown in FIG. 7, the layout conversion part 101B may proceed to determine the orientation of the mobile terminal 106 (step S1201). If the mobile terminal 106 is being held vertically, the layout conversion part 101B can simply continue to display the data as was previously displayed (step 1203). If, however, the layout conversion part 101B determines that the mobile terminal 106 is held horizontally, the layout conversion part 101B can be configured to convert the data being displayed on the screen to a print-ready file with a particular display font, format and page width corresponding to the new orientation of the device (step S1202).

FIG. 13A shows an example in which the mobile terminal 106 is operating in image priority, and the orientation of the mobile terminal 106 is changed from vertical (portrait view) orientation to horizontal (landscape view) orientation. While the orientation of the display is shifted in response to the rotational manipulation of the mobile terminal 106, the user, in either case, must scroll horizontally and vertically in order to navigate through the text on the screen.

On the other hand, in the example shown in FIG. 13B, the mobile terminal 106 is operating in text priority mode. In such circumstance, when the user changes the orientation of the mobile terminal 106, the layout conversion part 101B determines that the orientation of the mobile terminal 106 changed and converts the display to conform to a new line width. Since the line width has been adjusted, more text can be displayed per line, and the user merely has to scroll vertically in order to navigate through the text on the screen.

FIG. 14 depicts an example of a user interface screen, in which the user is permitted to select the display font. The user interface allows the user to customize the font of the text data including, but not limited to, type, size, color and style. Also, the user can specify (by operating the Multimedia: drop-down menu) whether graphics should be embedded along with text. The user may save the specified settings, and the layout conversion part 101B would retrieve the saved user preferences. However, at any time the user can request that the default settings be restored.

On the other hand, the user may specify to only keep the preference settings for one-time use only by selecting “OK”, as shown in FIG. 14. For example, the user may select the settings for font and embedded graphics and then select “OK” in order to maintain the default setting for future sessions.

When the user selects to print in text priority mode, a user interface screen, such as shown in FIG. 15, may be displayed to allow the user to select print options, such as, but not limited to, printer, pages to print, number of copies and paper size. The ADVANCED option allows the user to perform jobs that are available to the specific printer, such as, but not limited to, two-sided print and stapling. The “Pages” drop down menu refers to a user prompt to print only certain pages of the document, or all.

FIG. 16A depicts an example in which the terminal has a multi-touch touchscreen display that allows the user to zoom-in by expanding the distance between the touch points. When such zoom-in operation is specified in text priority mode, the layout conversion part 101B reformats the display, so that, as shown in FIG. 16B, there is no horizontal cutoff. It should be appreciated that such features can be implemented even if zoom-in is performed on a device that does not have a multi-touch touchscreen display.

In addition, when the user prompts the mobile terminal to perform a zoom-in action, the layout conversion part can record a history of user operations and associated font settings. At a later time, when operating in text priority mode, the layout conversion part 101B can be configured to automatically adjust the display based on such recorded history of user operations.

FIG. 17 shows an example of recorded user preference information (e.g., Type, Size, Color, Style, Effects, embedded graphics). In such example, the user may be allowed to specify his/her preferences, or as mentioned above, the user preference may be automatically determined, transparent to the user.

The aforementioned specific embodiments are illustrative, and many variations can be introduced on these embodiments without departing from the spirit of the disclosure or from the scope of the appended claims. For example, elements and/or features of different examples and illustrative embodiments may be combined with each other and/or substituted for each other within the scope of this disclosure and appended claims.

The orders in which the steps are performed in the aforementioned methods are not limited to those shown in the examples of FIGS. 6, 7, 10 and 12, and may be switched as long as similar results are achieved. Also, it should be noted that the methods illustrated in the examples of FIGS. 6, 7, 10 and 12 may be implemented using any of the embodiments shown in FIGS. 1A-1C.

What is claimed is:

1. A conversion apparatus for converting content to a format suitable for display on a mobile terminal that includes a display unit configured to display visual content, said conversion apparatus comprising:
a device information registration part that registers device display information associated with the mobile terminal; and
a layout conversion part that retrieves text data from a data source or a file, determines, based on the device display information associated with the mobile terminal, (i) a particular display font that is visually acceptable on the display unit of the mobile terminal to a user and (ii) a particular page format and a particular page width to permit the text data to be displayed on the display unit of the mobile terminal at the particular display font, and prints the text data to a print-ready file that is configured to capture the text data with the particular display font, the particular page format and the particular page width, and to be displayed on the display unit without horizontal cutoff of the text data.

2. The conversion apparatus of claim 1, wherein the print-ready file is a portable document format file set to the particular display font, the particular page format and the particular page width, such that when the portable document format file is displayed on the display unit of the mobile terminal, the text data is displayed without any horizontal cutoff on the display unit of the mobile terminal.

3. The conversion apparatus of claim 1, wherein in a case that the text data is extracted from a portable document format source file, the layout conversion part disregards page layout information in the source file, and determines the particular display font, the particular page format and the particular page width, based on the device display information associated with the mobile terminal and without considering the page layout information in the source file.

4. The conversion apparatus of claim 1, wherein said layout conversion part is an application provided to the mobile terminal via a network.

5. The conversion apparatus of claim 4, wherein a document is retrieved by the mobile terminal by using the application, and the layout conversion part converts the document to the print-ready file and returns the print-ready file to be displayed on the display unit without horizontal cutoff of the text.

6. The conversion apparatus of claim 4, wherein
said application causes a user interface to be displayed on the display unit of the mobile terminal, and said application causes the user interface to prompt the user to select between an image priority mode and a text priority mode, and
in a case that the text priority mode is selected, the layout conversion part proceeds to convert the text data to the print-ready file, based on the particular display font, the particular page format and the particular page width, determined from the device display information associated with the mobile terminal, and
in a case that the image priority mode is selected, the layout conversion part does not convert the text data and the text data is displayed based on a native page format or a default format.

7. The conversion apparatus of claim 4, wherein
said application causes the print-ready file to be archived in association with an original format file that includes the text data stored in a native page format or a default format, and
when the user selects or specifies a printer to print the text data, said application prompts the user to select between an image priority mode and a text priority mode,
in a case that the text priority mode is selected, the print-ready file is transmitted to the printer, and
in a case that the image priority mode is selected, the original format file is submitted as a print job to the printer.

8. The conversion apparatus of claim 1, wherein said layout conversion part is an application received from another device via a network.

9. The conversion apparatus of claim 1, wherein said layout conversion part causes the print-ready file to be archived in association with an original format file that includes the text data stored in a native page format or a default format.

10. The conversion apparatus of claim 1, wherein the print-ready file is a portable document format file set to the particular display font, the particular page format and the particular page width, such that when the portable document format file is displayed on the display unit of the mobile terminal, the text data is displayed without any horizontal cutoff on the display unit of the mobile terminal.

11. A mobile application including one or more programs of instructions embodied in a non-transitory computer readable medium and executable by a processor, wherein the mobile application executable by the processor comprises:
a user interface part that is configured to cause a user interface to be provided on a display unit of a mobile apparatus to permit a user to store a document to a remote location via a network and to retrieve the document from the remote location;
a device information registration part that registers device information associated with the mobile apparatus; and
a layout conversion part configured to convert a format of the document, based on user instruction received through the user interface, wherein
the layout conversion part determines, based on the device information associated with the mobile apparatus, (i) a particular display font that is visually acceptable on the display unit of the mobile apparatus to the user and (ii) a particular page format and a particular page width to permit text in the document to be displayed on the display unit of the mobile apparatus at the particular display font, and converts the document to a print-ready file that is configured to capture the text in the document with the particular display font, the particular page format and the particular page width, and to be displayed on the display unit of the mobile apparatus without horizontal cutoff of the text.

12. The mobile application of claim 11, wherein the print-ready file is a portable document format file set to the particular display font, the particular page format and the particular page width, such that when the portable document format file is displayed on the display unit of the mobile apparatus, the text is displayed without any horizontal cutoff on the display unit of the mobile apparatus.

13. The mobile application of claim 11, wherein said programs of instructions constituting the mobile application are received by the mobile apparatus from another device via a network.

14. The mobile application of claim 11, wherein the print-ready file is a portable document format file set to the particular display font, the particular page format and the particular page width, such that when the portable document format file is displayed on the display unit of the mobile apparatus, the text is displayed without any horizontal cutoff on the display unit of the mobile apparatus.

15. The mobile application of claim 11, wherein
the user interface part causes the user interface displayed on the display unit of the mobile apparatus to prompt the user to select between an image priority mode and a text priority mode, and
in a case that the image priority mode is selected, the layout conversion part does not convert the document and the document is displayed based on a native page format or a default format, and
in a case that the text priority mode is selected, the layout conversion part converts the document to the print-ready file that is configured to capture the text in the document and to be displayed on the display unit of the mobile apparatus without horizontal cutoff of the text.

16. The mobile application of claim 15, wherein in the case that the text priority mode is selected, the layout conversion part disregards page layout information in the document, and determines the particular display font, the particular page format and the particular page width, based on the device information associated with the mobile apparatus and without considering the page layout information in the document.

17. A non-transitory computer readable medium embodying a program of instructions executable by a processor of a mobile apparatus to perform a method for displaying a document on a display unit of the mobile apparatus, the method comprising:
receiving a request to retrieve a document;
retrieving device information associated with the mobile apparatus;
determining, based on the device information associated with the mobile apparatus, (i) a particular display font that is visually acceptable on the display unit of the mobile apparatus to a user and (ii) a particular page format and a particular page width to permit the document to be displayed on the display unit of the mobile apparatus at the particular display font; and
causing the document to be converted to a print-ready file that is configured to capture text in the document with the particular display font, the particular page format and the particular page width, and to be displayed on the display unit without horizontal cutoff of the text.

18. The non-transitory computer readable medium of claim 17, wherein the method performed by the mobile apparatus further comprises:
causing a user interface provided by the mobile apparatus to prompt the user to select between an image priority mode and a text priority mode; and
in a case that the text priority mode is selected, converting the document to the print-ready file, based on the particular display font, the particular page format and the particular page width, determined from the device display information associated with the mobile apparatus, and
in a case that the image priority mode is selected, displaying the document based on a native page format or a default format, without converting the document.

19. The non-transitory computer readable medium of claim 17, wherein the method performed by the mobile apparatus further comprises:
causing the print-ready file to be archived in association with an original format file that includes the document stored in a native page format or a default format.

20. A mobile apparatus comprising:
the conversion apparatus of claim 1, and
the mobile terminal.
